(19) United States
(12) Patent Application Publication
(10) Pub. No.: US 2010/0035105 A1
(43) Pub. Date: Feb. 11, 2010

(54) ELECTRICAL STORAGE DEVICE

(76) Inventor: Jan Petrus Human, Somerset West (ZA)

Correspondence Address: STITES & HARBISON PLLC, 1199 NORTH FAIRFAX STREET, SUITE 900, ALEXANDRIA, VA, 22314, US

(21) Appl. No.: 12/519,862

(22) PCT Filed: Dec. 21, 2007
(86) PCT No.: PCT/IB07/55274

§ 371 Date: Oct. 15, 2009

(30) Foreign Application Priority Data
Dec. 21, 2006 (ZA) 2006/10805

(51) Int. Cl. H01M 8/06; H01M 2/26; H01M 4/02; H01M 10/05; H01M 4/04

(52) U.S. Cl. 429/21; 429/158; 429/211; 429/50; 29/623.5

(57) ABSTRACT

A component for an electrochemical cell is disclosed which comprises a mass of electrochemically active paste with two or more electrically conductive, electrically isolated electrodes embedded in it. Terminals protrude from the mass and are electrically connected to the electrodes. The mass can be self supporting or can be in the form of a layer which is on one face of a porous substrate. Where paste on the other side of the substrate. The paste on one side of the substrate can be positive and the paste on the other side of the substrate negative, whereby the component constitutes a cell.

### FIELD OF THE INVENTION

THIS INVENTION relates to electrical storage devices.

### BACKGROUND TO THE INVENTION

Lead acid batteries are used widely. They are used in motor vehicles where the ability to provide a high starting current for a short period is a necessity. They are also used in installations where stand-by power is required in the event that the mains supply fails, but the installation is not of sufficient size to justify the provision of a stand-by generator. Such batteries, used in large numbers, have also been used to power the electric motors of delivery vehicles which only require a short range. Batteries of the lead acid type have been refined over the period of their existence but have not changed in any radical way since their first development.

For other purposes, such as powering electronic equipment where high current flow is not required, lithium iron and nickel cadmium batteries have been developed.

All the batteries mentioned above are of the so-called secondary type which means that they can be recharged.

In the specification of my PCT application PCT/IB2006/002784 (published as WO 2007/042892 on 19 Apr. 2007) there is disclosed an electrical storage battery which has positive and negative charging terminals and positive and negative discharging terminals. The battery's construction is based on lead plates with positive and negative paste thereon. The battery can charge and discharge simultaneously. When fitted, for example, to a motor vehicle the charging terminals are connected to the vehicle's alternator and the discharging terminals to the electrical equipment of the vehicle.

The object of the present invention is to provide an electrical storage battery which is of novel construction and which can, in common with that disclosed in the above identified PCT application, be charged and discharged simultaneously.

### BRIEF DESCRIPTION OF THE INVENTION

According to a first aspect of the present invention there is provided a component for an electrochemical cell comprising first and second electrically conductive tracks constituting electrodes, the tracks, apart from a connecting tab of each track, being embedded in electrochemically active battery paste and being physically separated from one another by said paste so that there is no direct electrical contact between the first and second tracks.

Each track preferably comprises a first electrode strip from which a plurality of parallel, spaced second electrode strips extend, the second strips of the tracks being intermeshed so that the second strips of the first track alternate with second strips of the second track.

To form an electrochemical cell two components as defined above are used, the electrochemically active paste of one component being positive and the electrochemically active paste of the other component being negative, the components being juxtaposed and there being a porous, electrically insulating spacer therebetween.

According to a second aspect of the present invention there is provided a component for an electrochemical cell, the component comprising a porous substrate having first and second electrically isolated, electrically conductive tracks on one side thereof, each track constituting an electrode and being connected to a respective terminal, and a layer of electrochemically active paste covering said tracks.

Said tracks can be provided on the substrate by moulding or otherwise forming the tracks and then securing them to the substrate. In this form tracks can be in grooves in the substrate. In an alternative form the tracks are provided by etching away a metal coating on the substrate to leave residual metal having the configuration of the tracks. Said residual metal can be coated with an acid resistant metal In a further method said tracks are provided by electroplating a porous substrate.

To form a cell the component can have third and fourth electrically isolated, electrically conductive tracks on the other side of the substrate, the third and fourth tracks constituting electrodes and being connected to respective battery terminals and there being electrochemically active battery paste covering said third and fourth tracks, the paste covering the first and second tracks being of the opposite polarity to the paste covering the third and fourth tracks.

To form a battery the terminals of the first, second, third and fourth tracks respectively are electrically connected to one another, whereby the battery has two negative and two positive terminals.

According to a third aspect of the present invention there is provided an electrochemical cell comprising a porous substrate having first and second electrically isolated electrically conductive tracks on one side thereof, the tracks constituting battery electrodes and being connected to respective terminals, a first layer of electrochemically active paste covering said first and second tracks, said first layer of electrochemically active paste and the first and second tracks constituting the cathode of the cell, third and fourth electrically conductive, electrically isolated tracks on the other side of the substrate, the third and fourth tracks being connected to respective terminals, and a second layer of paste covering said third and fourth tracks, the second layer of electrochemically active paste and the third and fourth tracks constituting the anode of the cell.

According to a fourth aspect of the present invention there is provided a component for an electrochemical cell comprising a substrate having a first electrically conductive track on one side thereof, the track being connected to a first battery terminal, a layer of electrochemically active positive paste covering said first track, a second electrically conductive track on the other side of the substrate, the second track being connected to a second battery terminal, and a layer of electrochemically active negative paste covering said second track.

To enable two or more charging sources to be used, and two or more power consuming devices to be powered, more than two tracks can be provided which are connected to respective charging and/or discharging terminals.

According to a fifth aspect of the present invention there is provided a of the method of manufacturing a component for an electrochemical cell which comprises forming a layer of electrochemically active paste, placing first and second electrically isolated, electrically conductive electrodes against said layer, and covering said electrodes with further paste thereby to embed the electrodes.

Said layer of paste can be formed in a mould box, the electrodes being placed on the layer and then being covered by a further paste.

### BRIEF DESCRIPTION OF THE DRAWINGS

For a better understanding of the present invention, and to show how the same may be carried into effect, reference will now be made, by way of example, to the accompanying drawings in which:

FIG. 1 is a pictorial view of a battery casing;

FIG. 2 is a front elevation of a cell component;

FIG. 3 is a section on the line III-III of FIG. 2 and illustrates a modified construction;

FIG. 4 is a pictorial view of the cell component of FIG. 2;

FIG. 5 is a pictorial view of an assembly of said components forming a battery cell;

FIG. 6 is a pictorial view of three battery cells;

FIG. 7 is a pictorial view of the cells of FIG. 6 with connectors and terminals fitted;

FIG. 8 shows the cells of FIG. 7 in the battery casing of FIG. 1;

FIG. 9 is a pictorial view of a further cell component;

FIG. 10 illustrates a battery including the component of FIG. 9;

FIG. 11 is a pictorial view of a further form of cell component;

FIG. 12 illustrates part of a battery electrode and part of a positioning element;

FIG. 13 is a section illustrating the production of the component of FIG. 11;

FIG. 14 is an edge view of a further component;

FIGS. 15 and 16 illustrate installations including batteries as shown in FIG. 8 or FIG. 10; and

FIG. 17 illustrates a fuel cell.

### DETAILED DESCRIPTION OF THE DRAWINGS

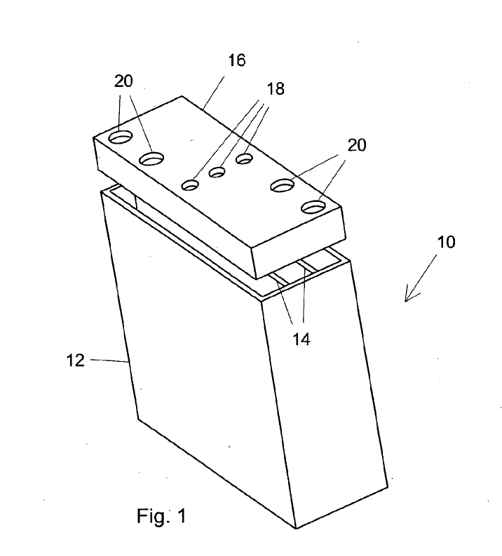

Referring firstly to FIG. 1, the battery casing 10 illustrated comprises a base 12 with two vertical partitions 14 therein and a cover 16 with seven holes in it. The row of holes 18, after the battery has been filled with electrolyte, are closed by plugs (not shown). The four terminals of the battery protrude through the holes 20.

Once the cells (described below) have been placed in the compartments defined by the partitions 14 and the walls of the casing 10, the cover 16 is heat sealed to the base 12.

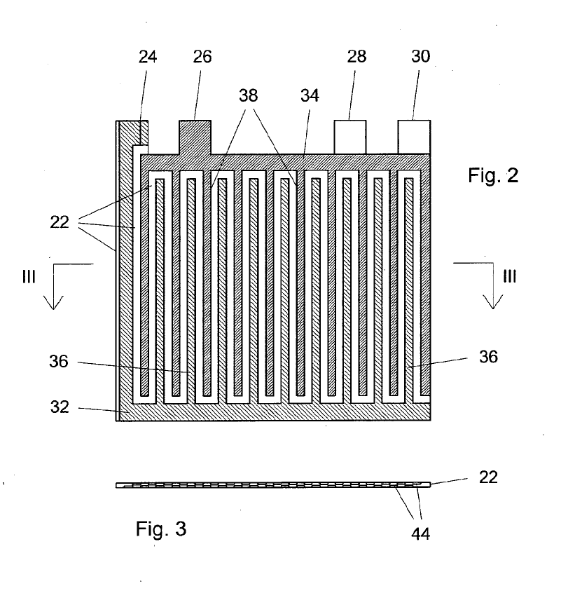

Turning now to FIG. 2, the structure illustrated comprises a substrate 22 which is of an electrically non-conductive material. The substrate can be of, for example, the material from which printed circuit boards (known as “Viroboard”) are manufactured. Such material is available in sheets and has a multitude of small holes in it. The holes permit electrolyte to enter into the material which can thus, for the purposes of the present invention, be considered as porous. It is also possible to use a material which has a wicking action and permits electrolyte to migrate through it. The substrate is of rectangular form with four integral tabs 24, 26, 28 and 30 protruding therefrom. As will be understood from the following description, only a small part of the substrate 22 is visible in FIG. 2.

Two electrically conductive tracks 32 and 34, each constituting a battery electrode, are provided on the visible face of the substrate 22. For ease of illustration the track 32 has been cross hatched in one direction and the track 34 has been cross hatched in the other direction and the visible part of the substrate 22 has been left plain.

The track 32 covers most of the tab 24 and extends along one vertical edge and along the lower horizontal edge of the substrate 22. Strips 36 of the track 32 protrude vertically upwardly from that portion of the track 32 which extends along the lower edge of the substrate.

The track 34 covers the tab 26 and extends across almost the entire width of the top edge of the substrate 22. Strips 38 extend downwardly from the part of the track 34 which extends along the top edge of the substrate. The strips 36 and 38 intermesh but do not touch. It is in this sense that the tracks are electrically isolated from one another.

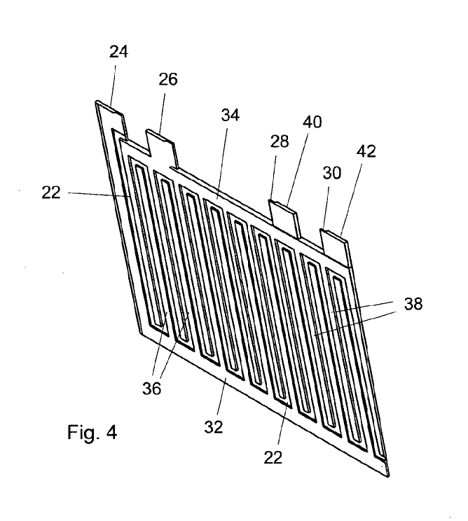

On the other side of the substrate there is an identical arrangement of tracks these tracks terminating at the tabs 28 and 30. Small parts of these tracks are visible at 40 and 42 in FIG. 4.

The tracks 32, 34, 40 and 42 can be produced using a substrate which has a thin layer of copper on each side. The layers are masked to protect the areas of copper which are to be retained and the exposed copper is etched away. After the masks are removed, the remaining copper is plated with an acid resistant metal such as lead, cadmium, lithium or nickel or with an acid resistant metal hydride. It is if possible that, in use, the remaining copper will be eroded but the acid resistant metal remains.

The faces of the substrate are then coated with an electrochemically active oxide paste which can be, for example, lead oxide, cadmium oxide, lithium oxide or nickel oxide. If lead is used then lead oxide which has carbon black in it and which is referred to as “Expander” can be used as the electrochemically active negative paste and lead oxide without carbon can be used as the electrochemically active positive paste.

The pastes entirely cover both faces of the substrate so that the tracks, apart from the parts on the tabs 24, 26, 28 and 30, are embedded in the pastes. The tracks constitute the electrodes of the plate.

The components of FIGS. 2, 3 and 4, having both electrodes and positive and negative electrochemically active paste, consequently have both an anode and a cathode and act as cells which produce a low voltage.

In the form of FIG. 3, the substrate has grooves 44 in both faces thereof, the tracks being in the grooves 44. The tracks in FIG. 3 can be cast or otherwise formed and then pressed into the grooves 44. Suitable means, such as interlocking parts of the grooves and tracks, can be provided for securing the tracks in place.

If the grooves in the substrate extend to the top and bottom edges of the substrate, the tracks can be slid into them instead of being pressed in. The part of the track 32 on the tab 24 of necessity for this purpose must terminate at the dashed line shown extending across the tab 24 so as to prevent the tracks interfering with one another as they are slid in.

In accordance with a further method of manufacture the tracks are cast or moulded and then located in the cavity of an injection mould. Once the mould has been closed, plastics material is injected into the narrow gap between the tracks to form the thin substrate 22. The plastics material of the moulded substrate is porous so as to allow electrolyte to permeate through it.

The intermeshing arrangement of the strips 36, 38 of the tracks 32, 34, 40, 42 ensures that the bulk of the volume of the paste is close to a track Whilst this arrangement is a simple one to achieve, any other track arrangement which results in the bulk of the two paste masses being adjacent the tracks can be employed.

It is also possible to electroplate acid resistant metal onto a thin substrate of porous synthetic plastics material, thereby to form the tracks.

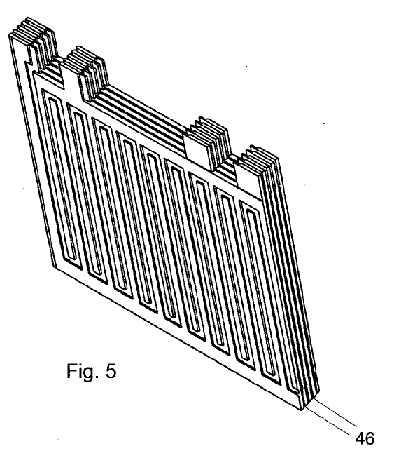

FIG. 5 shows five components as illustrated in FIGS. 2, 3 and 4 juxtaposed to one another with four porous acid resistant separators 46 therebetween. The structure of FIG. 5 constitutes a cell as this term is conventionally used.

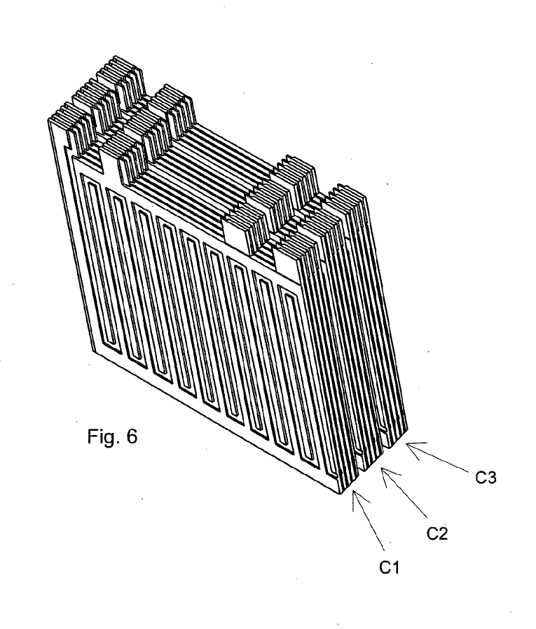

FIG. 6 is similar to FIG. 5 but shows three cells C1, C2 and C3 which together constitute a battery.

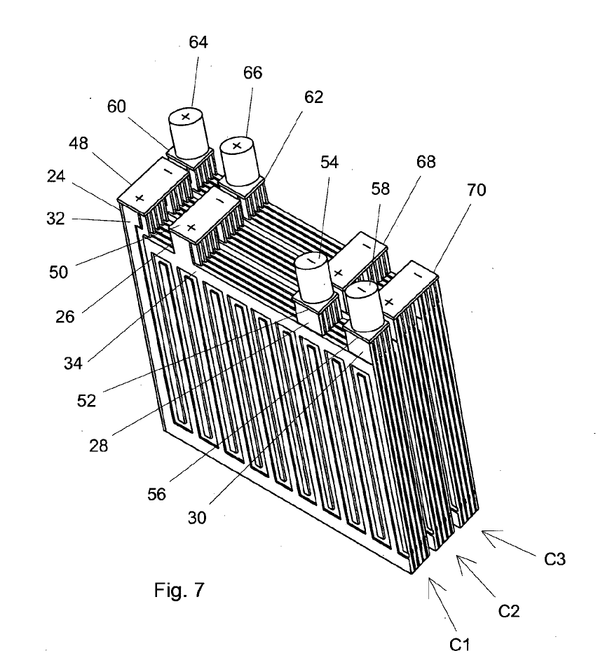

In FIG. 7 the cells are also designated C1, C2 and C3. The tracks 32 which extend onto the tabs 24 of the cells designated C1 and C2 are inter-connected by a bridge 48 and likewise the tracks 34 that terminate on the tabs 26 of the cells C1 and C2 have been interconnected by a bridge 50.

The tracks 40 which extend onto the tabs 28 of the cell C1 are connected by a bridge 52 from which a terminal 54 protrudes. Likewise the tracks 42 which extend onto the tabs 30 are interconnected by a bridge 56 from which a terminal 58 protrudes.

Bridges 60 and 62 connect the positive tracks of the cell C3 and terminals 64 and 66 protrude from the bridges 60 and 62. Bridges 68 and 70 join the positive tracks of the cell C2 to the negative tracks of the cell C3. The signs + and − have been inserted in FIG. 7 to indicate the polarity of the components.

Terminals 64 and E6 are the positive charging and positive discharging terminals and terminals 54 and 58 are the negative discharging and charging terminals. The material forming the electrode tracks used for charging can be of a greater conductivity than the conductive material constituting the tracks used for discharging.

In FIG. 8 the three cells C1, C2 and C3 are in the compartments of the base 12. As the cover 16 is pressed onto the base, the terminals 54, 58, 64 and 66 protrude through the holes 20. The electrolyte is poured in and plugs (not shown) inserted into the filling holes 18.

The electrolytically active pastes which covers the tracks are porous and the electrolyte permeates the paste. As the substrate 22 is perforated, or is otherwise porous, the electrolyte eventually bridges between the two layers of paste. It is for this reason that it is stated above that the component of FIG. 2, having both negative and positive paste material, with electrolyte in contact with both, itself constitutes a cell.

If it is not intended that the cell described in the preceding paragraph be capable of simultaneous charge and discharge, then the tracks 32 and 34 can be electrically connected to one another and to a single terminal. Likewise the tracks 40, 42 can be electrically connected to one another and to a single terminal.

Experimental work has shown that battery “self regulates” when the charging current is derived from a solar panel, the battery being fully charged at dusk when solar power is lost. Experimental work has further shown that by regulating the charging and discharging currents “over charging” is possible when solar power or another source is used to generate the charging current. This results in the production of hydrogen and oxygen gas which bubbles-off and can be collected.

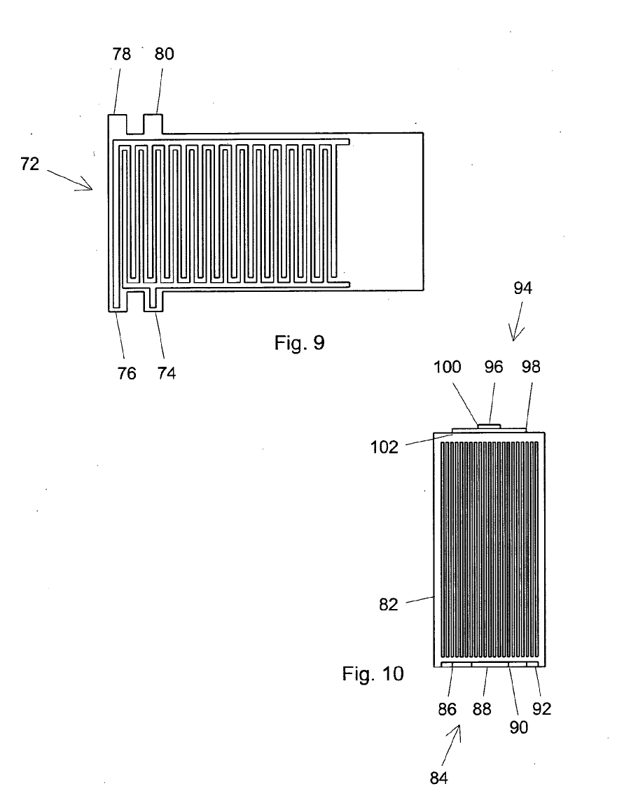

A further cell component 72 is shown in FIG. 9. The substrate of the plate 72 is thin, flexible and porous and can be rolled into cylindrical form. The major differences between the cell component of FIG. 2 and the component of FIG. 9 are that the component 72 is of elongate rectangular form (as opposed to substantially square) and that the tabs designated 74, 76, 78 and 80 are positioned differently. These protrude two from each of the opposed longer edges of the substrate as opposed to the tabs in FIG. 2 which all protrude from the same edge.

The battery of FIG. 10 comprises a cylindrical casing 82 which is closed at one end by a terminal structure designated 84. The structure 84 comprises two terminals 86, 88 which are insulated from one another and from the remainder of the casing by separators designated 90 and 92.

The other end of the casing is closed by a further terminal structure designated 94. The structure 94 also provides two terminals designated 96 and 98 which are isolated electrically from one another and from the casing by separators 100 and 102.

The tabs 74, 76, 78 and 80 are connected to respective ones of the terminals 86, 88, 96 and 98. This provides, at one end of the casing, negative charging and discharging terminals and, at the other end of the casing, positive charging and discharging terminals.

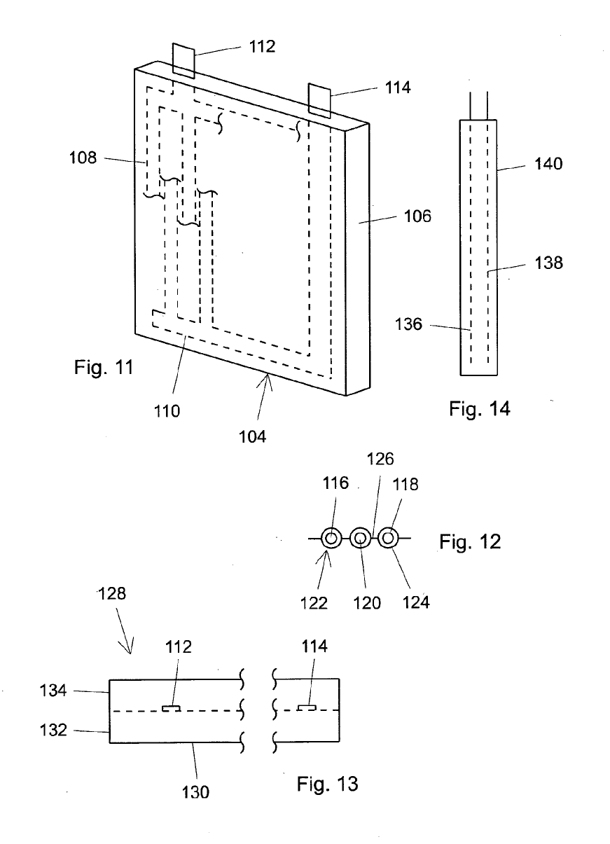

The cell component 104 shown in FIG. 11 comprises a rectangular mass 106 of electrochemically active battery paste which is produced as will be described hereinafter with reference to FIG. 13.

Embedded in the paste are two tracks 108, 110 of the form illustrated in FIG. 2. The tracks are positioned in the mass of battery paste in such manner that they are physically isolated from one another and consequently not in direct electrical contact. The connecting tabs 112, 114 of the tracks protrude from the upper edge of the mass of paste.

The tracks can be cast or moulded or fabricated from individual components that are welded or otherwise secured together. For smaller batteries the tracks can be constituted by thin strips of electrically conductive material. For larger batteries the tracks can be of thicker bars of rectangular or round cross section. Each embedded track constitutes an electrode.

To ensure that there is no direct electrical contact between the tracks, positioning elements can be used. In FIG. 12 the round bars 116, 118 form part of one track and the bar 120 forms part of another track. The illustrated positioning element 122 comprises loops 124 for receiving the bars and straps 126 joining the loops 124. The element 122 is of an electrically insulating material which is resistant to corrosion by the battery paste and electrolyte to which it is exposed.

The component of FIG. 11 can be produced in a rectangular mould box 128 such as is shown in FIG. 13. The mould box has a base 130 including a lower wall part 132 and a loose upperwall part 134.

A layer of paste is initially placed in the mould box, the layer being about half the thickness of the mass that constitutes the finished battery plate and being scrapped off level with the top edge of the lower wall part 132.

The two tracks are then placed on the paste layer and positioned so that there is no direct contact between them. The tabs 112, 114 protrude beyond the wall part 132. The part 134 is placed on the part 132 and the mould box is then filled with paste to the level of the upper edges of the walls of the part 134 thereby to embed the tracks in the paste. The part 134 is configured to fit around the protruding tabs 112, 114.

It will be understood that larger batteries, such as are used to provide standby power, have more massive constructions than do, for example, motor vehicle batteries. In the above embodiments, the tracks constituting the electrodes are in the same plane. However, in larger batteries the mass of paste constituting the plate is thick enough to permit the tracks to be spaced apart in the direction of the thickness of the mass. In FIG. 14 electrically isolated electrodes 136, 138 are shown side by side in the mass 140 of electrochemically active paste.

The end of the useful life of a battery is often reached due to corrosion of the electrodes. Unless the current through the battery has consistently been above the design value, the paste is normally still in usable condition.

It is possible, in accordance with the present invention, to provide electrodes which can be replaced if corroded. To achieve this the mass of paste is cast around formers of plastic or metal which taper in such manner that they can readily be withdrawn from the paste after it has hardened. This leaves tapering cavities in the paste into which the metal electrodes can be inserted. These electrodes can be withdrawn for replacement if this proves necessary.

In all forms of the cell components described above there are two electrodes in each mass of paste. It is, however, possible to incorporate more than two electrodes into each paste mass, with a commensurate increase in the number of terminals.

Insofar as charging is concerned, having two charging electrodes enables two or more power sources to be connected to the battery for charging purposes. On the discharge side the electrodes can be used to provide different power out puts.

In accordance with another method of manufacture, a web of the porous substrate can be fed downwardly between two rollers. Each roller has in the face thereof a pattern of grooves which replicates the tracks that are required on the substrate. Paste is fed into the nip between the rollers on both sides of the substrate. The rollers are of a material to which the paste will not adhere and the substrate is of a material to which the paste will adhere. As the rollers turn, paste fills the grooves and is transferred onto both faces of the substrate.

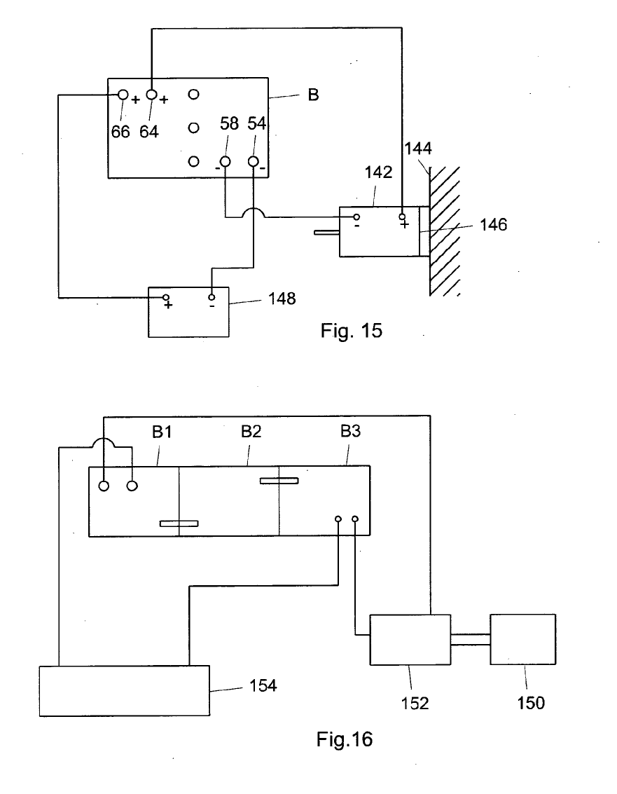

Turning now to FIG. 15, thus illustrates an installation incorporating a battery as described above. The battery is designated B.

Reference numeral 142 designates a source of 12 volt d.c charging current. This can be an a.c alternator with a rectifier and, if necessary, a transformer. The alternator body is not earthed but is secured so that it is isolated from the sub-structure 144 on which it is mounted. An insulation pad is shown at 146. The sub-structure can be the metal body of a motor vehicle. The positive and negative terminals of the source 142 of d.c charging current are connected to the battery terminals 64 and 58, respectively.

A power consuming means is generally designated 148 and could, for example, be all the devices on a motor vehicle that consume power. The fuel pump is a prime power consumer when a vehicle's engine is running and at night the lights also consume considerable power. The means 148 is connected across the battery terminals 66 and 54.

It will be understood that in the illustrated installation, the power consuming means 148 is supplied from the battery B and not directly from the power source 142.

Experimental work has shown that a motor vehicle having an electrical installation as shown in FIG. 15 consumes less fuel per 100 Km driven than a motor vehicle with a conventional layout in which power is taken directly from the source 142 and the battery only provides power to the starter motor and “stand-by” power to other electrical equipment of the vehicle whilst the engine is switched-off and the source 142 is not generating.

In FIG. 15 the source 142 can be an electricity generating solar panel, the battery B can be of the lithium iron or the nickel cadmium type and the means 128 can be electronic equipment such as a cell phone. The solar panel can be affixed to the outer surface of the cell phone casing and, when exposed to light, provides charging current to the battery B.

In the installation of FIG. 16 there are three batteries B1, B2 and B3 connected in series and providing a voltage of about 36 volts. Reference numeral 150 designates a petrol or diesel engine which drives a source of d.c. charging current 152 which can be a generator or alternator. The output terminals of the source 152 are connected across the charging terminals of the batteries B1, B2 and B3.

An electric motor 154 is driven by the batteries B1, B2 and B3 and is connected across the discharging terminals. The installation illustrated in FIG. 16 is suitable for powering a motor vehicle.

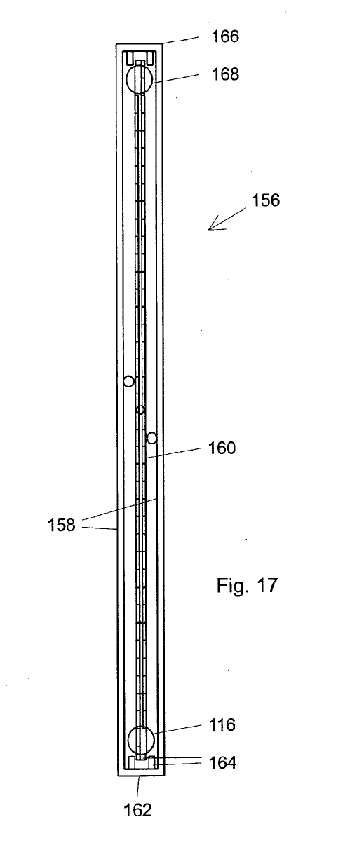

In FIG. 17 reference numeral 156 designates a fuel cell which can be used to produce electrical power from hydrogen and oxygen supplied thereto or to produce hydrogen and oxygen when electrical power is supplied thereto, or which is reversible and can be used for both purposes.

The fuel cell 156 comprises a casing having main walls 158 which define between them a compartment sufficient in size to receive a battery plate 160 as described with reference to FIGS. 1 to 4 or a battery plate as described with reference to FIG. 9. The narrow end walls 162 have on them vertically extending ribs 164 into which the vertical edges of the plate 160 slide. The ribs 164 and the vertical edges co-operate to seal-off the space on one side of the plate 160 from the space on the other side so that gases cannot flow between these spaces.

The upper end of the casing is closed by a tightly fitting or sealed on cover 166 having two gas inlet and outlet ports 168 therein. The cover 166 and the upper edge of the plate 160 form a seal thereby isolating said spaces.

Each port 168 has a vertical partition therein which subdivides the port. The parts of the port 168 each communicate respectively with one of said spaces, the partition preventing gases in the parts of the ports mixing. The cover has two passages therein, each passage leading to one of the parts of the port 168.

The opposite faces of the plate act as an anode and a cathode, hydrogen and oxygen being generated whilst current is flowing. The generated gases flow from the casing via the parts of the port 168 and into the passages.

A plurality of cells 156 such as shown in FIG. 17 can be contained within a housing which provides a plurality of parallel walls 158 as shown in FIG. 17. This provides a plurality of compartments. The cover is ported and provided with passages which enable the oxygen generated to be directed to a common outlet and the hydrogen generated to be directed to another common outlet.

1. Component for an electrochemical cell comprising first and second electrically conductive tracks constituting electrodes, the tracks, apart from a connecting tab of each track, being embedded in electrochemically active battery paste and being physically separated from one another by said paste so that there is no direct electrical contact between the first and second tracks.

2. A component as claimed in claim 1, wherein each track comprises a first electrode strip from which a plurality of parallel, spaced second electrode strips extend, the second strips of the tracks being intermeshed so that the second strips of the first track alternate with second strips of the second track.

3. An electrochemical cell comprising two components as claimed in claim 1, the electrochemically active paste of one component being positive and the electrochemically active paste of the other battery plate being negative, the plates being juxtaposed and there being a porous, electrically insulating spacer therebetween.

4. A component for an electrochemcial cell, the component comprising a porous substrate having first and second electrically isolated, electrically conductive tracks on one side thereof, each track constituting an electrode and being connected to a respective terminal, and a layer of electrochemically active paste covering said tracks.

5. A component as claimed in claim 4, wherein the tracks are provided on the substrate by moulding or otherwise forming the tracks and then securing them to the substrate.

6. A component as claimed in claim 5, wherein the tracks are in grooves in the substrate.

7. A component as claimed in claim 4, wherein the tracks are provided by etching away a metal coating on the substrate to leave residual metal having the configuration of the tracks.

8. A component as claimed in claim 7, wherein said residual metal is coated with an acid resistant metal.

9. A component as claimed in claim 4, wherein said tracks are provided by electroplating a porous substrate.

10. A component as claimed in claim 4 and having third and fourth electrically isolated, electrically conductive tracks on the other side of the substrate, the third and fourth tracks constituting electrodes and being connected to respective battery terminals and there being electrochemically active battery paste covering said third and fourth tracks, the paste covering the first and second tracks being of the opposite polarity to the paste covering the third and fourth tracks.

11. A battery comprising a plurality of cells as claimed in claim 10, the terminals of the first, second, third and fourth tracks respectively being electrically connected to one another, whereby the battery has two negative and two positive terminals.

12. An electrochemical cell comprising a porous substrate having first and second electrically isolated electrically conductive tracks on one side thereof, the tracks constituting battery electrodes and being connected to respective terminals, a first layer of electrochemically active paste covering said first and second tracks, said first layer of electrochemically active paste and the first and second tracks constituting the positive of the cell, third and fourth electrically conductive, electrically isolated tracks on the other side of the substrate, the third and fourth tracks being connected to respective terminals, and a second layer of paste covering said third and fourth tracks, the second layer of electrochemically active paste and the third and fourth tracks constituting the negative of the cell.

13. A component for an electrochemical cell comprising a substrate having a first electrically conductive metal track on one side thereof, the track being connected to a first battery terminal, a layer of electrochemically active positive paste covering said first track, a second electrically conductive metal track on the other side of the substrate, the second track being connected to a second battery terminal, and a layer of electrochemically active negative paste covering said second track.

14. A component as claimed in claim 13, and including more than two tracks thereby to enable more than two charging sources and/or more than two power consuming devices to be connected to respective charging and/or discharging terminals.

15. A method of manufacturing a component for an electrochemical cell which comprises forming a layer of electrochemically active paste, placing first and second electrically isolated, electrically conductive electrodes against said layer, and covering said electrodes with further paste thereby to embed the electrodes.

16. A method as claimed in claim 15, wherein said layer of paste is formed in a mould box, the electrodes being placed on the layer and then being covered by a further paste.

17. A fuel cell which is able to produce electricity when hydrogen and oxygen are fed thereto, and which produces hydrogen and oxygen when an electric current flows through it, the cell being constructed using components as claimed in claim 13.

18. A component as claimed in claim 1, wherein the material of the first track is of greater conductivity than the material of the second track.

19. A method of operating an electrical cell as claimed in claim 3 which comprises so charging the cell that gaseous hydrogen and gaseous oxygen are generated which bubble-off and are collected.

20. A component as claimed in claim 1 and including more than two tracks thereby to enable more than two charging sources and/or more than two power consuming devices to be connected to respective charging and/or discharging terminals.

21. A component as claimed in claim 4, and including more than two tracks thereby to enable more than two charging sources and/or more than two power consuming devices to be connected to respective charging and/or discharging terminals.

22. A fuel cell which is able to produce electricity when hydrogen and oxygen are fed thereto, and which produces hydrogen and oxygen when an electric current flows through it, the cell being constructed using components as claimed in claim 1.

23. A fuel cell which is able to produce electricity when hydrogen and oxygen are fed thereto, and which produces hydrogen and oxygen when an electric current flows through it, the cell being constructed using components as claimed in claim 4.
